(19) United States
(12) Patent Application Publication
(10) Pub. No.: US 2017/0198224 A1
(43) Pub. Date: Jul. 13, 2017

(54) FISCHER-TROPSCH GASOIL FRACTION

(71) Applicant: SHELL OIL COMPANY, HOUSTON, TX (US)

(72) Inventors: Johannes Bernardus Wilhelmus MORSINK, Amsterdam (NL); Johannes TURFBOER, Amsterdam (NL); Rendert Jan WIERSMA, Amsterdam (NL); Ferry WINTER, Amsterdam (NL)

(73) Assignee: SHELL OIL COMPANY, HOUSTON, TX (US)

(21) Appl. No.: 15/313,772

(22) PCT Filed: May 26, 2015
(86) PCT No.: PCT/EP2015/061521

§ 371 Date: Nov. 23, 2016

(30) Foreign Application Priority Data
May 28, 2014 (EP) 14170221.7

(51) Int. Cl. C10G 2/00; C09K 8/34; C06B 43/00; C10G 47/00

(52) U.S. Cl. CPC C10G 2/332; C10G 47/00; C09K 8/34; C06B 43/00; C10G 2300/301; C10G 2400/06

(57) ABSTRACT

The present invention provides a Fischer-Tropsch gasoil fraction having: (a) an initial boiling point of at least 220° C.; (b) a final boiling point of at most 360° C.; (c) a kinematic viscosity at 25° C. according to ASTM D445 of from 3.8 to 4.4 cSt; and (d) of a flash point according to ASTM D93 of at least 100° C. In another aspect the present invention provides a composition and the use of a Fischer-Tropsch gasoil fraction according to the invention.

The present invention relates to a Fischer-Tropsch gasoil fraction, drilling fluid composition and slurry and ANFO explosives compositions comprising the Fischer-Tropsch gasoil fraction, and use of the Fischer-Tropsch gasoil fraction.

Fischer-Tropsch derived gasoils may be obtained by various processes. A Fischer-Tropsch derived gasoil is obtained using the so-called Fischer-Tropsch process. A Fischer-Tropsch process produces a range of hydrocarbon products, including naphtha, gasoil, base oil and other products. The gasoil product is also referred to as the full-range Fischer-Tropsch derived gasoil. An example of such process producing a Fischer-Tropsch derived gasoil is disclosed in WO 02/070628.

In U.S. Pat. No. 5,906,727, a Fischer-Tropsch derived solvent based on a full-range Fischer-Tropsch derived gasoil is disclosed with a boiling range from approximately 160 to 370° C.

There is a need in the art for Fischer-Tropsch gasoil fractions that have a more narrow boiling point range compared to the solvent disclosed in U.S. Pat. No. 5,906,727.

It has now surprisingly been found that specific Fischer-Tropsch gasoil fractions of the full-range Fischer-Tropsch derived gasoil can be advantageously used in drilling fluid and slurry explosives or Ammonium Nitrate & Fuel Oil (ANFO) explosives applications.

To this end, the present invention provides a Fischer-Tropsch gasoil fraction having:
(a) an initial boiling point of at least 220° C.;
(b) a final boiling point of at most 360° C.;
(c) a kinematic viscosity at 25° C. according to ASTM D445 of from 3.8 to 4.4 cSt; and
(d) a flash point according to ASTM D93 of at least 100° C.

An advantage of the present invention is that the Fischer-Tropsch gasoil fraction has surprisingly a low viscosity while having a high flash point, which combination of properties provides advantages in drilling fluid and slurry explosives or ANFO explosives applications. Crude oil derived, dearomatized gasoils (also referred to as base fluids), although classified as Group III types drilling base fluids, are less environmentally benign in comparison with the synthetically derived Fischer-Tropsch gasoil fractions according to the invention.

Typically, the Fischer-Tropsch gasoil fraction according to the present invention has very low levels of aromatics, naphthenic paraffins (also referred to as naphthenics) and impurities. The low level of impurities, aromatics and naphthenics gives the Fischer-Tropsch gasoil fraction according to the present invention an improved odor compared to crude oil derived gasoil, even after dearomatization. While the presence of normal paraffins and mono-methyl branched isoparaffins (mono-methyl isoparaffins) may provide improved bio-degradability compared to other isoparaffins.

The Fischer-Tropsch gasoil fraction according to the present invention is a fraction of the full-range Fischer-Tropsch gasoil that is derived from a Fischer-Tropsch process. Full-range Fischer-Tropsch derived gasoil, herein also referred to as Fischer-Tropsch gasoil, is known in the art. By the term “Fischer-Tropsch derived” is meant that the gasoil, is, or is derived from, a synthesis product of a Fischer-Tropsch process. In a Fischer-Tropsch process, synthesis gas is converted to a synthesis product. Synthesis gas or syngas is a mixture of predominantly hydrogen and carbon monoxide that is obtained by conversion of a hydrocarbonaceous feedstock. Suitable feedstocks include natural gas, crude oil, heavy oil fractions, coal, biomass or lignocellulosic biomass and lignite. A Fischer-Tropsch derived gasoil may also be referred to as a GTL (Gas-to-Liquids) gasoil. The Fischer-Tropsch gasoil is characterized as the product of a Fischer-Tropsch process wherein a synthesis gas, or mixture of predominantly hydrogen and carbon monoxide, is processed at elevated temperature over a supported catalyst comprised of a Group VIII metal, or metals, e.g., cobalt, ruthenium, iron, etc. At least part of the Fischer-Tropsch product is contacted with hydrogen, at hydrocracking/hydroisomerization conditions over a, preferably, bifunctional, catalyst, or catalyst containing a metal, or metals, hydrogenation component and an acidic oxide support component active in producing both hydrocracking and hydroisomerization reactions. A least part of the resulting hydrocracked/hydroisomerized Fischer-Tropsch product may be provided as the Fischer-Tropsch derived gasoil feedstock.

Fischer-Tropsch gasoils are different from crude oil-derived gasoils. Despite having a similar boiling point range, the specific molecular composition of the Fischer-Tropsch gasoils may allow for, amongst others, improved viscosity characteristics, improved pour point characteristics, improved density characteristics and in particular a combination of any of the aforementioned characteristics with specific desired flash point characteristics. For example, Fischer-Tropsch gasoils may combine a low volatility with a high flash point, whereas the viscosity of such Fischer-Tropsch gasoils may be lower than the viscosity of crude oil-derived gasoil feedstock having a similar volatility and flash point.

The different characteristics of the Fischer-Tropsch gasoils, compared to the crude oil-derived gasoils, are generally attributed to their particular isoparaffin to normal paraffin weight ratio (i/n ratio), relative amount of mono-methyl branched isoparaffins and the molecular weight distribution of the paraffins.

A particular advantage of the Fischer-Tropsch derived gasoils is that these gasoils are almost colorless. Color as used herein is the Saybolt color as measured by its Saybolt number (ASTM D156: Standard Test Method for Saybolt Color of Petroleum Products). A high Saybolt number, +30, indicates colorless fluids, whereas lower Saybolt numbers, in particular below zero, indicate a discoloration. A Saybolt number lower than 25 already indicates the presence of a visually observable discoloration. Fischer-Tropsch gasoils typically have the highest Saybolt number, i.e. +30. The good color characteristics, together with the above mentioned improved viscosity, pour point, density and flash point characteristics make the Fischer-Tropsch derived gasoils highly suitable for drilling fluid, also referred to as a drilling mud, and slurry explosives or ANFO explosives applications.

It has now been found that it may be possible to meet specific requirements of particular applications of the Fischer-Tropsch derived gasoil by using a specific fraction of a Fischer-Tropsch gasoil, wherein the fraction has a more narrow boiling point range compared to the full-range Fischer-Tropsch gasoil. By fractionating the Fischer-Tropsch gasoil, isoparaffins and normal paraffins are distributed unevenly over the fractions and Fischer-Tropsch gasoil fractions may be obtained that have an i/n ratio different from the original Fischer-Tropsch gasoil. Also the relative amount of mono-methyl isoparaffins and the molecular weight distribution of the paraffins may be different. As a consequence the viscosity, pour point, density and flash point characteristics of the Fischer-Tropsch gasoil fractions may be changed, beyond the change that would be expected on the basis of a fractionation on the basis of boiling ranges alone. Fischer-Tropsch gasoil contain primarily isoparaffins, however they also contain normal paraffins. Preferably, the Fischer-Tropsch gasoil fraction comprises more than 70 wt % of isoparaffins, preferably more than 75 wt % of isoparaffins.

A fraction of the Fischer Tropsch gasoil is a narrower boiling range distillation cut of the Fischer Tropsch gasoil.

According to the present invention, the Fischer-Tropsch gasoil fraction has an initial boiling point of at least 220° C. and a final boiling point of at most 360° C. at atmospheric conditions. Suitably, the Fischer-Tropsch gasoil fraction has an initial boiling point of at least 230° C., more preferably at least 234° C., at atmospheric conditions.

The Fischer-Tropsch gasoil fraction preferably has a final boiling point of at most 350° C., at atmospheric conditions. Further, the Fischer-Tropsch gasoil fraction preferably has a final boiling point of at most 338° C., at atmospheric conditions. By excluding lower boiling hydrocarbons that normally considered to be part of a full-range Fischer-Tropsch gasoil the fraction may have a lower volatility and hence a higher flash point, which is an important property when used in drilling fluids or explosives as it provides a general safety improvement. By excluding higher boiling hydrocarbons that normally considered to be part of a full-range Fischer-Tropsch gasoil the viscosity of the fraction may be lowered.

A preferred Fischer-Tropsch gasoil fraction has an initial boiling point of at least 234° C. and a final boiling point of at most 338° C., at atmospheric conditions.

By boiling points at atmospheric conditions is meant atmospheric boiling points, which boiling points are determined by ASTM D86.

Preferably, the Fischer-Tropsch gasoil fraction has a T10 vol % boiling point from 241 to 259° C., more preferably from 2244 to 256° C., most preferably from 247 to 253° C. and a T90 vol % boiling point from 306 to 324° C., preferably from 3309 to 321° C. and more preferably from 312 to 318° C.

T10 vol % boiling point is the temperature corresponding to the atmospheric boiling point at which a cumulative amount of 10 vol % of the product is recovered. Similarly, T90 vol % boiling point is the temperature corresponding to the atmospheric boiling point at which a cumulative amount of 90 vol % of the product is recovered. The atmospheric distillation method ASTM D86 is used to determine the level of recovery.

The Fischer-Tropsch gasoil fraction comprises preferably paraffins having from 10 to 27 carbon atoms; the Fischer-Tropsch gasoil fraction comprises preferably at least 70 wt %, more preferably at least 85 wt %, more preferably at least 90 wt %, more preferably at least 95 wt %, and most preferably at least 98 wt % of Fischer-Tropsch derived paraffins having 10 to 27 carbon atoms based on the total amount of Fischer-Tropsch derived paraffins.

Further, the Fischer-Tropsch gasoil fraction preferably has a density at 15° C. according to ASTM D4052 from 808 kg/m³ to 814 kg/m³, more preferably from 809 kg/m³ to 813 kg/m³, and most preferably from 810 kg/m³ to 812 kg/m³.

Suitably, the kinematic viscosity at 25° C. according to ASTM D445 is from 3.8 to 4.4 cSt, preferably from 3.9 cSt to 4.3 cSt, and more preferably from 4.0 cSt to 4.2 cSt.

Preferably, the flash point the Fischer-Tropsch gasoil fraction has a flash point according to ASTM D93 of at least 100° C., preferably of from 100 to 114° C., more preferably from 103 to 111° C., and most preferably from 104 to 110° C.

The Fischer-Tropsch gasoil fraction has a smoke point according to ASTM D1322 of more than 50 mm.

Typically, the Fischer-Tropsch gasoil fraction according to the present invention comprises less than 500 ppm aromatics, preferably less than 360 ppm aromatics, more preferably less than 300 ppm aromatics, less than 3 ppm sulphur, preferably less than 1 ppm sulphur, more preferably less than 0.2 ppm sulphur, less than 1 ppm nitrogen and less than 4 wt % naphthenics, preferably less than 3 wt % and more preferably less than 2.5 wt % naphthenics.

Further, the Fischer-Tropsch gasoil fraction preferably comprises less than 0.1 wt % polycyclic aromatic hydrocarbons, more preferably less than 25 ppm polycyclic aromatic hydrocarbons and most preferably less than 1 ppm polycyclic aromatic hydrocarbons.

The amount of isoparaffins is suitably more than 70 wt % based on the total amount of paraffins having from 10 to 27 carbon atoms, preferably more than 75 wt %.

Further, the Fischer-Tropsch gasoil fraction may comprise normal paraffins, also referred to as n-paraffins, and cyclo-alkanes.

The Fischer-Tropsch gasoil fraction preferably has an isoparaffin to normal paraffin weight ratio (also referred to as i/n ratio) of in the range of from 4 to 6. This i/n ratio may advantageously affect amongst others the viscosity of the Fischer-Tropsch gasoil fraction. The concentration of isoparaffin may be high enough to benefit a lower overall viscosity. At the same time the significant amount of normal paraffins may benefit the bio-degradability.

Preferably, the Fischer-Tropsch gasoil fraction comprises in the range of from 25 to 45 wt %, more preferably of from 30 to 40 wt %, of mono-methyl branched isoparaffins, based on the total weight of isoparaffins in the Fischer-Tropsch gasoil fraction. Mono-methyl branched isoparaffins exhibit desirable bio degradation characteristic compared to other isoparaffins. A relative high concentration of mono-methyl isoparaffins to other isoparaffins may advantageously affect amongst others the bio degradation characteristics of the Fischer-Tropsch gasoil fractions. A higher relative concentration of mono-methyl isoparaffin to other isoparaffins may provide the Fischer-Tropsch gasoil fraction with bio degradation characteristics beyond the bio degradation characteristics of the Fischer-Tropsch gasoil.

The Fischer-Tropsch gasoil fraction has a much narrower boiling range compared to the Fischer-Tropsch gasoil, allowing for its use in many applications. Due to its relative highly paraffinic nature and relative low levels of naphthenic and aromatic components and in addition the relative low levels of impurities, the Fischer-Tropsch gasoil fraction of the invention incorporates several technical benefits over conventional, crude oil derived fluids. Compared to existing isoparaffinic fluids currently on the market, the Fischer-Tropsch gasoil fraction has a more desirable mix of isoparaffins and n-paraffins. While competitive isoparaffinic fluids predominantly contain isoparaffins, and especially the higher boiling isoparaffins, including naphthenic paraffins, this Fischer-Tropsch gasoil fraction of the invention contains isoparaffins and n-paraffins, while containing very minor amounts of naphthenic paraffins.

When used in for instance drilling fluid and slurry explosives or ANFO explosives applications the low odor and relatively low toxicity, due to the low aromatic content, are a distinct benefit as well as the improved bio degradation due to the high concentration of normal paraffins and mono-methyl isoparaffins. The low level of impurities allow for a beneficial use in drilling fluid applications. Crude oil derived, dearomatized base fluids, although classified as Group III types drilling base fluids, are less environmentally benign in comparison with the Fischer-Tropsch gasoil fractions according to the invention. Also the crude oil derived diesel and kerosene used in formulation slurry and ANFO explosives may be less bio degradable than the Fischer-Tropsch gasoil fractions according to the present invention.

A high flash point is desirable for safety reasons. Where prior art gasoils used for these application suffered from an undesired high viscosity when using a high flash point gasoil, the Fischer-Tropsch gasoil fraction of the present invention having its specific composition and branching provides a high flash point while maintaining a viscosity that is relatively low compared to prior art isoparaffinic fluids, at same flash point levels. For safety and environmental reasons, high flash point, low toxicity, readily biodegradable base fluids are preferred in the oil production area as well as the explosives industry, while for the suitability to be used in formulations and energy saving reasons a low viscosity is preferred. At the same time, the Fischer-Tropsch gasoil fractions according to the invention have a lower vapor pressure than prior art high flash point base fluids used in drilling fluids.

The combination of having a low viscosity and at the same time a relatively high flash point may find its benefits in drilling fluids and slurry explosives or ANFO explosives applications as low viscosity is a highly desired property in drilling fluid and slurry explosives or ANFO explosives applications.

The preparation of the Fischer-Tropsch gasoil feedstock used as a basis for the Fischer-Tropsch gasoil fraction of the present invention has been described in e.g. WO02/070628 and WO-A-9934917 (in particular the process as described in Example VII of WO-A-9934917, using the catalyst of Example III of WO-A-9934917), both of which are hereby incorporated by reference. As mentioned above these Fischer-Tropsch derived gasoil feedstocks have a different molecular composition and have significantly different properties compared to crude oil-derived gasoil feedstock. Therefore, Fischer-Tropsch derived gasoil feedstocks can be clearly distinguished from crude oil-derived gasoil feedstocks.

In a further aspect, the present invention provides a composition comprising a Fischer-Tropsch derived gasoil fraction according to the invention. One particularly preferred composition is a drilling fluid composition, comprising the Fischer-Tropsch gasoil fraction as a high flash point base fluid. Another particularly preferred composition is an explosives composition, comprising the Fischer-Tropsch gasoil fraction as a carrier, a viscosity modifier and/or the fuel oil. The Fischer-Tropsch gasoil fraction may be used in combination with other compounds in the composition. Typically, a drilling fluid composition will comprise normal drilling fluid compounds. In case the Fischer-Tropsch gasoil fraction is comprised in an explosives composition, the composition will comprise at least explosive compounds or mixtures of compounds, such as ammonium nitrate. Other compounds that are used in combination with the Fischer-Tropsch gasoil fraction include additives for functional fluid formulations such as, but are not limited to, corrosion and rheology control products, emulsifiers and wetting agents, borehole stabilizers, high pressure and anti-wear additives, de- and anti-foaming agents, pour point depressants, pH controllers, viscosifiers, weighting agents, filtration reducers, brines, and antioxidants. Preferably, the other compounds comprise one or more compounds of corrosion and rheology control products, emulsifiers and wetting agents, borehole stabilizers, high pressure and anti-wear additives, de- and anti-foaming agents, pour point depressants, pH controllers, viscosifiers, weighting agents, filtration reducers, brines and antioxidants.

In another aspect, the invention provides for the use of the Fischer-Tropsch gasoil fraction in various applications. The Fischer-Tropsch gasoil fraction may be used alone or in combination with other compounds. Typically, Fischer-Tropsch gasoil fraction may be used in many areas, for instance oil and gas exploration and production, process oils, agro chemicals, process chemicals, construction industry, food and related industries, paper, textile and leather, and various household and consumer products. Other compounds that are used in combination with the Fischer-Tropsch gasoil fraction include additives for functional fluid formulations such as, but are not limited to, corrosion and rheology control products, emulsifiers and wetting agents, borehole stabilizers, high pressure and anti-wear additives, de- and anti-foaming agents, pour point depressants, and antioxidants.

Preferred applications using the Fischer-Tropsch gasoil fraction according to the present invention include, but is not limited to, drilling fluids, heating fuels or oil, lamp oil, barbeque lighters, concrete demoulding, pesticide spray oils, paints and coatings, personal care and cosmetics, consumer goods, pharmaceuticals, industrial and institutional cleaning, adhesives, inks, air fresheners, sealants, water treatment, cleaners, polishes, car dewaxers, electric discharge machining, transformer oils, process oil, process chemicals, silicone mastic, two stroke motor cycle oil, metal cleaning, dry cleaning, lubricants, metal work fluid, aluminum roll oil, explosives, chlorinated paraffins, heat setting printing inks, timber treatment, polymer processing oils, rust prevention oils, shock absorbers, greenhouse fuels, fracturing fluids and fuel additives formulations.

In particular the invention provides the use of a Fischer-Tropsch gasoil fraction according to the invention or a composition comprising such Fischer-Tropsch gasoil fraction in drilling fluids.

Equally particular the invention provides the use of a Fischer-Tropsch gasoil fraction according to the invention or a composition comprising such Fischer-Tropsch gasoil fraction in explosives compositions.

The present invention is described below with reference to the following Examples, which are not intended to limit the scope of the present invention in any way.

### EXAMPLES

### Example 1

### Preparation of a Fischer-Tropsch Gasoil Fraction Having an Initial Boiling Point of 234° C. and a Final Boiling Point of 388° C.

A Fischer-Tropsch product was prepared in a process similar to the process as described in Example VII of WO-A-9934917, using the catalyst of Example III of WO-A-9934917. The C₅+ fraction (liquid at ambient conditions) of the product thus obtained was continuously fed to a hydrocracking step (step (a)). The C₅+ fraction contained about 60 wt % C₃₀+ product. The ratio C₆₀+/C₃₀+ was about 0.55. In the hydrocracking step the fraction was contacted with a hydrocracking catalyst of Example 1 of EP-A-532118. The effluent of step (a) was continuously distilled under vacuum to give light products, fuels and a residue “R” boiling from 370° C. and above. The conversion of the product boiling above 370° C. into product boiling below 370° C. was between 45 and 55 wt %. The residue “R” was recycled to step (a). The conditions in the hydrocracking step (a) were: a fresh feed Weight Hourly Space Velocity (WHSV) of 0.8 kg/l·h, recycle feed WHSV of 0.4 kg/l·h, hydrogen gas rate=1000 Nl/kg, total pressure=40 bar, and a reactor temperature in the range of from 330° C. to 340° C.

The obtained fuels fraction (C5⁺—370° C.) was continuously distilled to give a Fischer-Tropsch gasoil fraction having an initial boiling point of 234° C. and a final boiling point of 388° C. and an approximate gasoil fraction yield as given in Table 1. The physical properties are given in Table 2.

TABLE 1
Fischer-Tropsch gasoil fraction

| | |
|---|---|
| Yield | 54 |
| ASTM D2892 [wt %] | |

TABLE 2
Fischer-Tropsch gasoil fraction

| | |
|---|---|
| Kinematic viscosity at 25° C. | 4.1 |
| According to ASTM D445 | |
| [mm²/s] | |
| content of aromatics | <200 |
| According to SMS 2728 | |
| [mg/kg] | |
| content of n-paraffins | 17.3 |
| According to GCxGC - internal | |
| testing methodology | |
| [wt %] | |
| content of isoparaffins | 81 |
| According to GCxGC - internal | |
| testing methodology | |
| [wt %] | |
| Density at 15° C. according | 811 |
| ASTM D4052 | |
| [kg/m³] | |
| T10 vol. % boiling point | 250 |
| According to ASTM D86 | |
| [° C.] | |
| T90 vol. % boiling point | 315 |
| According to ASTM D86 | |
| [° C.] | |
| Smoke point | >50 |
| [mm] | |
| Carbon number range paraffins | 10-27 |
| Flash point | 107 |
| According to ASTM D93 | |
| [° C.] | |
| content of monomethyl | 34 |
| isoparaffins | |
| According to GCxGC - internal | |
| testing methodology | |
| [wt %, based on total | |
| isoparaffins] | |
| Visual Appearance | Clear and bright |

### Example 2

To test the suitability of the Fischer-Tropsch gasoil fraction prepared in Example 1 for use in a drilling fluid composition, a drilling fluid composition was prepared composed of the components shown in Table 3.

TABLE 3

| Ingredient | | |
|---|---|---|
| Fischer-Tropsch gasoil fraction* | [g] | 190.8 |
| Emulsifier | [g] | 10 |
| (Le Supermul, ex. Halliburton) | | |
| Lime | [g] | 2.0 |
| (alkalinity buffer, pH controller, | | |
| carbonate remover) | | |
| filtration reducer | [g] | 1.0 |
| (Adapta, ex Halliburton) | | |
| 25% CaCl₂ Brine | [ml] | 94.5 |
| Organophilic clay | [g] | 2.0 |
| (viscosifier, Geltone V, ex Halliburton), | | |
| Barite | [g] | 225.0 |
| (weighting agent) | | |
| Viscosifier | [g] | 1.0 |
| (Rhemod L, ex. Halliburton) | | |

*as prepared in Example 1

The resulting drilling fluid composition has a density of 1438 gram/l (12 lb/gallon (US)) and a 70/30 oil to water ratio.

The following characteristics of the resulting drilling fluid composition were tested:

### Plastic Viscosity

The plastic viscosity is determined at a set temperature as the delta between the viscosity of the drilling fluid composition measured at 600 rpm and the viscosity the drilling fluid composition measured at 300 rpm in centipoise. The viscosity measurement is performed using a Fann 35 viscometer and measured at multiple shear rates.

A low plastic viscosity is preferred and indicates that the fluid is capable of drilling rapidly because of the low viscosity of fluid exiting at the bit (high Rate of Penetration (ROP)).

### Yield Point

The yield point is the viscosity of the drilling fluid composition measured at 300 rpm minus plastic viscosity measured in centipoise at a set temperature.

Yield point is a measure for the resistance to initial flow, i.e. the stress required to start fluid movement. The yield point is reported in lbf/100 ft².

The yield point is used to evaluate the ability of fluid to lift cuttings out of the annulus. A higher YP is preferred and implies that drilling fluid has ability to carry cuttings better than a fluid of similar density but lower yield point.

### Electrical Stability

Electrical stability value (measured in volts) reflects to the stability of the emulsion of the fluid. If water disperses well in oil phase (good emulsion), the resistivity of drilling fluid will be higher. In contrast, if water disperses badly in oil phase (bad emulsion), the resistivity of drilling fluid will be lower. Using an electrical stability meter, electricity from the electrical stability meter is emitted in to fluid and voltage is measured by the electrical probe electrical stability meter.

### Gel Strength

The gel strength (measured in lbf/100 ft²) is a measure for the ability of a fluid to suspend solids while the drilling fluid composition is in static condition. Before testing gel strength, the drilling fluid composition must be agitated for a while in order to prevent solids precipitation and subsequently allow the drilling fluid composition remain in static condition for a certain set time (10 seconds, 10 minutes) and then open the viscometer at 3 rpm and read the maximum reading value.

In Table 4 the measured plastic viscosity, yield point, electrical stability value and gel strengths are reported at two temperatures, 21.1° C. and 48.8° C. (70° F. and 120° F.).

TABLE 4

| | | | | |
|---|---|---|---|---|
| Temperature | [° C.] | | 21.1 | 48.8 |
| Plastic Viscosity | [cP] | | 25 | 18 |
| Yield point | [lbf/100 ft²] | | 18 | 18 |
| Gel Strength | [lbf/100 ft²] | 10 sec | 12 | 9 |
| | | 10 min | 15 | 15 |
| Electrical | [V] | | 450 | 450 |
| stability | | | | |

The characteristics as reported in Table 4 are similar to those that can be obtained when preparing the drilling fluid composition with a prior art crude oil based gasoil fraction. However, the Fischer-Tropsch gasoil fraction of the present invention allows for a combination of the characteristics as shown in Table 4, with i.e. compared to prior art crude oil based gasoil fractions, an improved biodegradability as well as a favorable combination of a low viscosity with a high flash point. This combination of properties of the Fischer-Tropsch gasoil fraction of the present invention gives the Fischer-Tropsch gasoil fraction of the present invention a clear advantage over the use prior art crude oil based gasoil fractions.

1. A Fischer-Tropsch derived gasoil fraction having an initial boiling point of at least 220° C. and a final boiling point of at most 360° C.

2. A Fischer-Tropsch derived gasoil fraction according to claim 1, having an initial boiling point of at least 230° C.

3. A Fischer-Tropsch derived gasoil fraction according to claim 1, having a final boiling point of at most 350° C.

4. A Fischer-Tropsch derived gasoil fraction according to claim 1, having a kinematic viscosity at 25° C. according to ASTM D445 of from 1.4 to 2.6 cSt.

5. A Fischer-Tropsch derived gasoil fraction according to claim 1, having a flash point according to ASTM D93 of at least 75° C.

6. A Fischer-Tropsch derived gasoil fraction according to claim 1, containing no more than 4 wt % of naphthenic paraffins, based on the Fischer-Tropsch derived gasoil fraction.

7. A Fischer-Tropsch derived gasoil fraction according to claim 1, containing isoparaffins and normal paraffins in a weight ratio of isoparaffins over normal paraffins in the range of 4 to 6.

8. A composition comprising a Fischer-Tropsch derived gasoil fraction according to claim 1.

9. A composition according to claim 8, wherein the composition is a drilling mud.

10. A composition according to claim 8, wherein the composition is an explosives composition.

11-12. (canceled)
